(19) United States
(12) Patent Application Publication
(10) Pub. No.: US 2006/0153347 A1
(43) Pub. Date: Jul. 13, 2006

(54) Method and system to enable submission and subsequent retrieval of enhanced voice mail messages

(76) Inventors: David William Clark, Carp (CA); Gregory A. Lam, Toronto (CA); Sean M. Murray, Toronto (CA); David Edward Johnston, Whitby (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/289,580

(22) Filed: Nov. 30, 2005

Related U.S. Application Data
(63) Continuation of application No. PCT/CA05/01517, filed on Sep. 30, 2005.
(60) Provisional application No. 60/638,386, filed on Dec. 27, 2004.

(51) Int. Cl. H04M 11/00

(52) U.S. Cl. 379/88.18

(57) ABSTRACT

A method suitable for execution by a voice mail system for handling a call placed by a caller. The method comprises providing the caller with an opportunity to submit a voice segment and providing the caller with an opportunity to submit an auxiliary electronic message, such as text or files. A composite message comprising the voice segment and the auxiliary electronic message is stored in a database. The auxiliary electronic message is released to its intended recipient upon subsequent interaction between the intended recipient and the voice mail system. The ability of the caller to submit text or files increases the accuracy and flexibility with which certain types of information can be conveyed to the intended recipient. At the same time, the ability of the intended recipient to access text or files associated with individual messages allows the intended recipient to better manage missed calls when eventually accessing his or her mailbox.

### CROSS-REFERENCE TO RELATED APPLICATIONS

This application is a CONTINUATION of PCT Patent Application Serial No. PCT/CA2005/001517, filed on Sep. 30, 2005, designating the United States and hereby incorporated by reference herein.

This application CLAIMS THE BENEFIT under 35 U.S.C. 119(e) of U.S. Provisional Patent Application Ser. No. 60/638,386 to Dave Clark et al., filed Dec. 27, 2004 and hereby incorporated by reference herein.

The subject matter of the present application is related to the subject matter of U.S. Provisional Patent Application Ser. No. 60/638,391 to Dave Clark et al., filed Dec. 27, 2004 and hereby incorporated by reference herein.

The subject matter of the present application is also related to the subject matter of PCT Patent Application Serial No. PCT/CA2005/001514, entitled “SYSTEMS AND METHODS FOR RENDERING VOICE MAIL CONTACT INFORMATION AVAILABLE TO A CALLED PARTY”, filed on Sep. 30, 2005, designating the United States and hereby incorporated by reference herein.

The subject matter of the present application is also related to the subject matter of PCT Patent Application Serial No. PCT/CA2005/001516, entitled “SYSTEMS AND METHODS FOR REGISTRATION AND RETRIEVAL OF VOICE MAIL CONTACT INFORMATION”, filed on Sep. 30, 2005, designating the United States and hereby incorporated by reference herein.

### FIELD OF THE INVENTION

The present invention relates generally to telecommunications and, more particularly, to techniques for enhancing voice mail messages with auxiliary content.

### BACKGROUND

Voice mail systems provide a convenient way for a caller to leave a message for an intended recipient who is unavailable to answer an incoming call. Specifically, when the intended recipient is busy or unresponsive to the call, a conventional voice mail system will answer the call and play the intended recipient's audio greeting. Following this, the caller is prompted to record a voice mail message, which is stored as an audio recording in a voice mailbox associated with the intended recipient.

When the intended recipient wishes to retrieve the contents of the mailbox at a later time, he or she dials into the voice mail system. The voice mail system authenticates the intended recipient, and subsequently allows the intended recipient, who is the owner of the mailbox, to navigate through his or her mailbox in order to perform various functions, such as playback, deletion and forwarding of individual voice mail messages.

Frequently, the intended recipient may find that they he or she has amassed a large number of voice mail messages in his or her mailbox, with a high variability amongst the messages in duration, relevance and/or importance. The intended recipient must therefore spend a considerable amount of time navigating through the voice mail messages, with no prior knowledge of the relative importance or context of a particular one of these messages. In some cases, this may lead to the intended recipient having wasted valuable time, only to discover that there are few or no voice mail messages requiring his or her immediate attention. Other situations may arise where an intended recipient who defers navigation through the voice mail system until a period of greater availability, may fail to retrieve crucial information in a timely fashion.

Thus, the industry would welcome an improvement that overcomes one or more of the aforementioned deficiencies.

### SUMMARY OF THE INVENTION

According to a first broad aspect, the present invention seeks to provide a method suitable for execution by a voice mail system for handling a call placed by a caller. The method comprises providing the caller with an opportunity to submit a voice segment destined for an intended recipient; providing the caller with an opportunity to submit an auxiliary electronic message destined for the intended recipient; storing in a mailbox associated with the intended recipient a composite message comprising the voice segment and the auxiliary electronic message; and releasing the auxiliary electronic message to the intended recipient upon interaction with the intended recipient.

According to a second broad aspect, the present invention seeks to provide computer-readable media tangibly embodying a program of instructions executable by a computing device to perform a method of handling a call placed by a caller. The method comprises providing the caller with an opportunity to submit a voice segment destined for an intended recipient; providing the caller with an opportunity to submit an auxiliary electronic message destined for the intended recipient; storing in a mailbox associated with the intended recipient a composite message comprising the voice segment and the auxiliary electronic message; and releasing the auxiliary electronic message to the intended recipient upon interaction with the intended recipient.

According to a third broad aspect, the present invention seeks to provide a voice mail system, comprising a plurality of mailboxes associated with respective users of the voice mail system. Each of the mailboxes comprises a respective set of at least one message. At least one particular message in the mailbox associated with a particular user comprises a respective voice content field and a respective auxiliary content field. The voice content field of the particular message comprises a voice segment submitted by a caller during prior interaction with the voice mail system. The auxiliary content field of the particular message comprises an auxiliary electronic message information submitted by the caller during said prior interaction with the voice mail system. The voice mail system further comprises a control unit operative for interacting with the particular user to allow the particular user to retrieve the voice segment in the voice content field of the particular message as well as the auxiliary electronic message in the auxiliary content field of the particular message.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIGS. 1A through 1E show how a voice mail system can be reached by a caller using various types of devices and in various network architectures;

FIG. 2 is a flowchart showing steps in the operation of the voice mail system when handling a missed call from the caller, in accordance with a possible embodiment of the present invention;

FIGS. 3A through 3E show how a mailbox in a voice mail system can be reached by the owner of the mailbox using various types of devices and in various network architectures; and

FIGS. 4 and 5 are signal flow diagrams showing steps in the operation of the voice mail system when interacting with the owner of the mailbox, in accordance with two possible embodiments of the present invention.

### DETAILED DESCRIPTION OF EMBODIMENTS

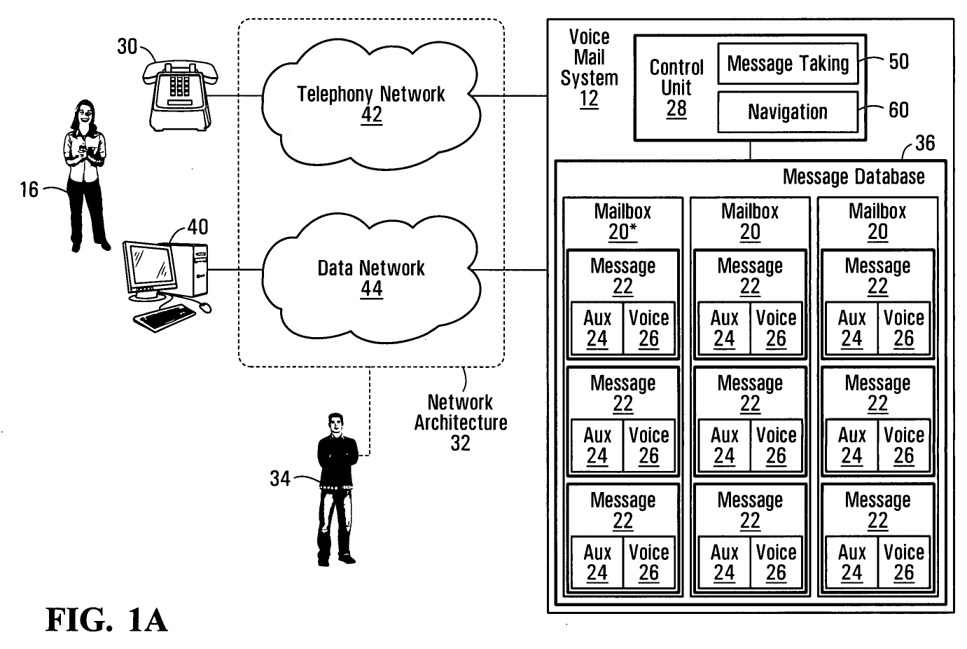

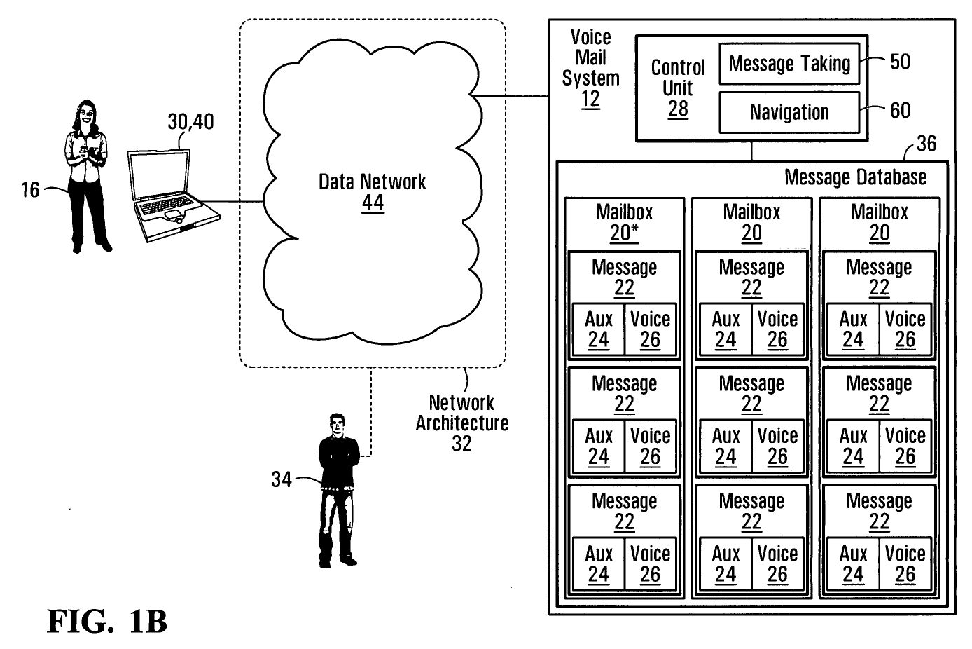

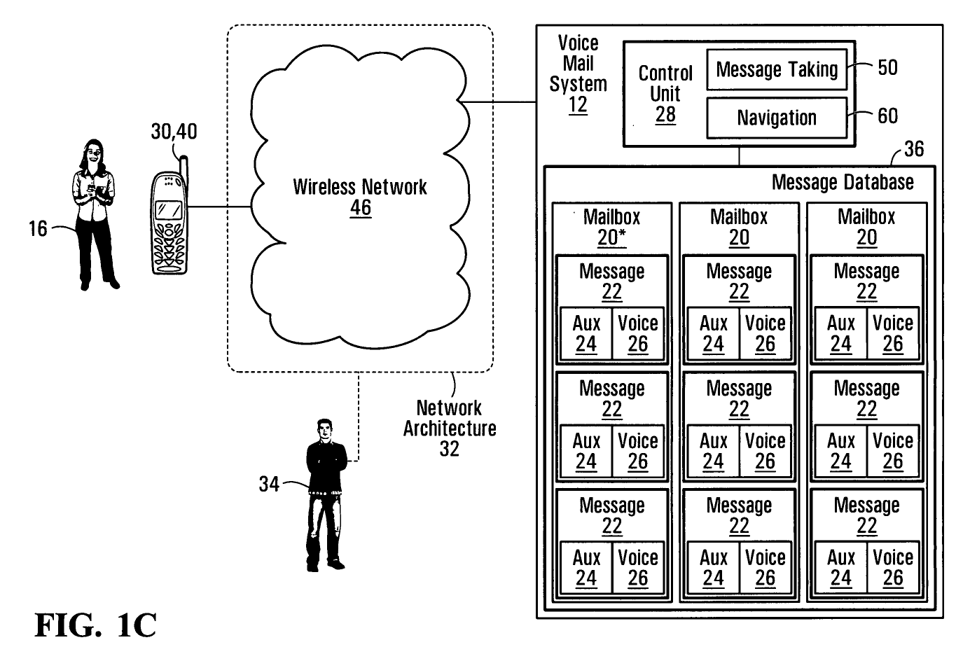

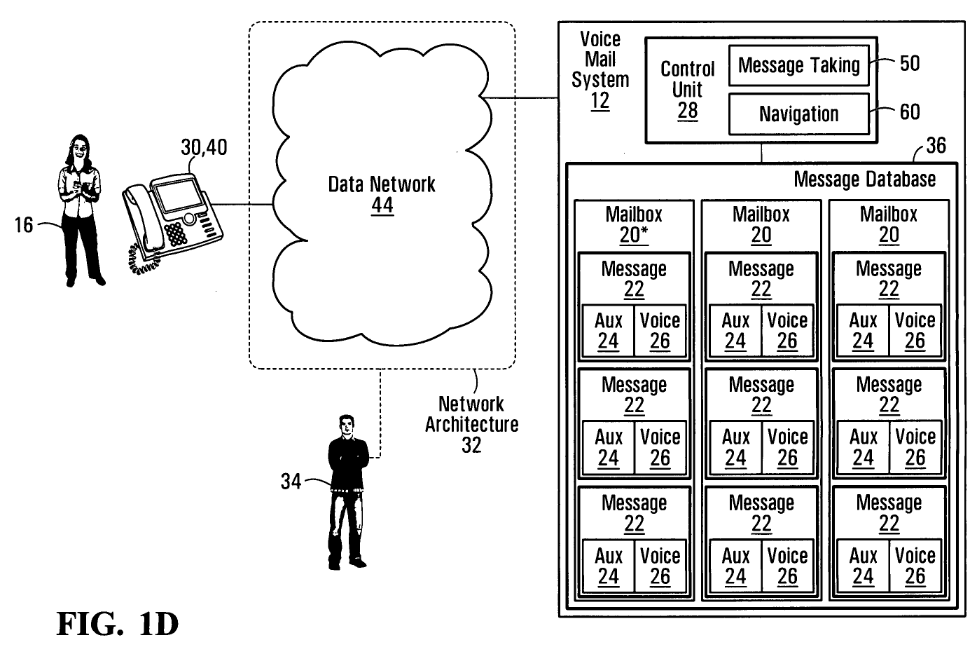

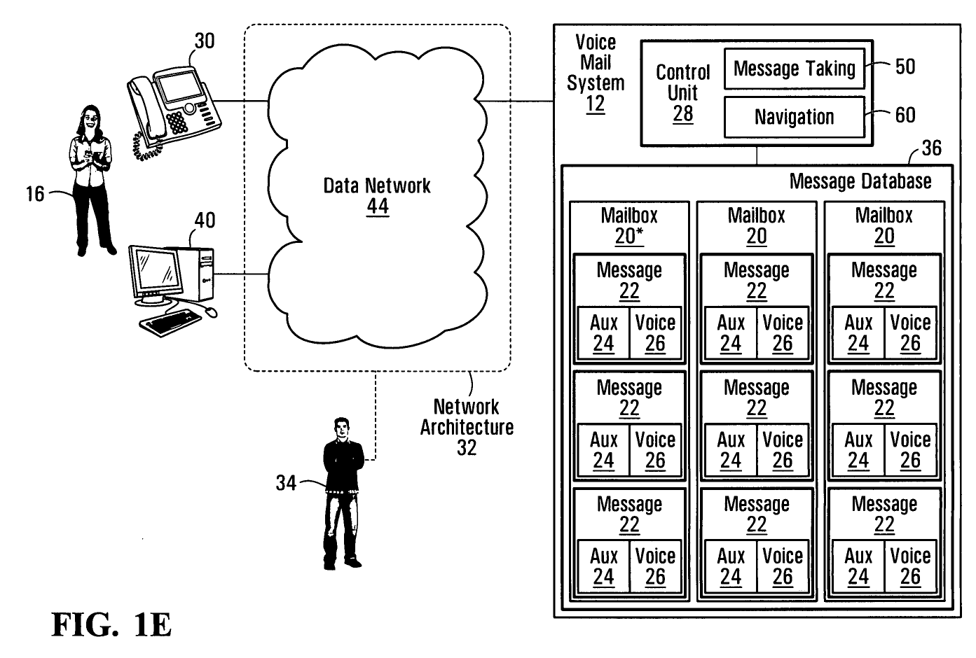

FIGS. 1A-1E show a plurality of scenarios in which a caller 16 uses a telephony device 30 to attempt to reach an intended recipient 34 over a network architecture 32. The attempt to reach the intended recipient 34 can be invoked by dialing a telephone number associated with the intended recipient 34. If the intended recipient 34 cannot be reached (e.g., if the intended recipient 34 does not respond after a certain number of rings or a busy signal is detected), the network architecture 32 transfers the call to a voice mail system 12. By interacting with the voice mail system 12, the caller 16 can leave a message for the intended recipient 34.

The voice mail system 12 comprises, or is in communication with, a mailbox database 36 that includes a plurality of mailboxes 20, including a mailbox 20*. Each of the mailboxes 20 in the mailbox database 36 is associated with a respective intended recipient and has the capability of storing one or more respective messages. In the illustrated example, the intended recipient 34 is the owner of mailbox 20*.

I-Interaction Between Voice Mail System 12 and Caller 16

The voice mail system 12 also comprises a control unit 28 that runs a message taking process 50 for interacting with the caller 16 to allow the caller 16 to leave a message 22 for the intended recipient 34. In accordance with an embodiment of the present invention, the message 22 is in fact a composite message having a voice content field 26 and an auxiliary content field 24. The caller 16 utilizes the telephony device 30 for populating the voice content field 26. In addition, and in accordance with an embodiment of the present invention, an auxiliary device 40 may be used by the caller 16 to populate the auxiliary content field 24. However, it should be noted that other messages 22, although not illustrated as such in the drawings, may contain only the voice content field 26 or only the auxiliary content field 24.

The telephony device 30 may be the same as the auxiliary device 40 or the two devices may be different, as will now become apparent from a discussion of the non-limiting examples in FIGS. 1A through 1E.

In the embodiment of FIG. 1A, the network architecture 32 comprises a telephony network 42 such as the PSTN and a data network 44 such as the Internet. In this embodiment, the telephony device 30 can be a conventional telephone connected to the telephony network 42. The auxiliary device 40 can be a computing apparatus with a connection to the data network 44. In some embodiments, the auxiliary device 40 may connect to the data network 44 via the telephony network 42. The voice mail system 12 is connected to both the telephony network 42 and to the data network 44.

In the embodiment of FIG. 1B, the network architecture 32 comprises a data network 44 such as the Internet. In this embodiment, the telephony device 30 is the same as the auxiliary device 40, and can be referred to as a common device 30, 40. The common device 30, 40 can be a soft client enabled device (e.g., a telephony-enabled desktop, laptop or portable computer) connected to the data network 44. The voice mail system 12 is connected to the data network 44. In some embodiments, the voice mail system 12 and/or the common device 30, 40 may connect to the data network 44 via a telephony network (not shown).

In the embodiment of FIG. 1C, the network architecture 32 comprises a wireless network 46 such as a cellular network. In this embodiment, the telephony device 30 is the same as the auxiliary device 40, and can be referred to as a common device 30, 40. The common device 30, 40 can be a wireless device such as a cellular telephone or a networked personal digital assistant (PDA). The wireless device can have a small screen and a keypad with a plurality of keys. The voice mail system 12 is connected to the wireless network 46. In some embodiments, the voice mail system 12 and/or the common device 30, 40 may connect to the wireless network 46 via a telephony network (not shown).

In the embodiment of FIG. 1D, the network architecture 32 comprises a data network 44 such as the Internet. In this embodiment, the telephony device 30 is the same as the auxiliary device 40, and can be referred to as a common device 30, 40. The common device 30, 40 can be an IP phone. The IP phone can have a screen and a plurality of keys, which have different functions depending on the information displayed on the screen. The IP phone may thus implement “soft key” functionality. The voice mail system 12 is connected to the data network 44. In some embodiments, the voice mail system 12 may connect to the data network 44 via a telephony network (not shown).

In the embodiment of FIG. 1E, the network architecture 32 comprises a data network 44 such as the Internet. In this embodiment, the telephony device 30 can be an IP phone and the auxiliary device 40 can be a computing apparatus. The voice mail system 12 is connected to the data network 44. In some embodiments, the voice mail system 12 and/or the auxiliary device 40 may connect to the data network 44 via a telephony network (not shown).

As mentioned above, the message taking process 50 is adapted for interacting with the caller 16 to allow the caller 16 to create a message 22 for the intended recipient 34. The message taking process 50, which may be run in hardware, software, control logic or any combination thereof, is now described in greater detail.

Message Taking Process 50

Firstly, the message taking process 50 interacts with the caller 16 in a known way to allow the caller 16 to record a voice segment for the intended recipient 34. Specifically, the control unit 28 stores the recorded voice segment in the voice content field 26 of a newly created message 22 for the intended recipient 34. In a non-limiting example embodiment, the recorded voice segment can be stored as a computer-readable file in a specific format including but not limited to “.wav” files.

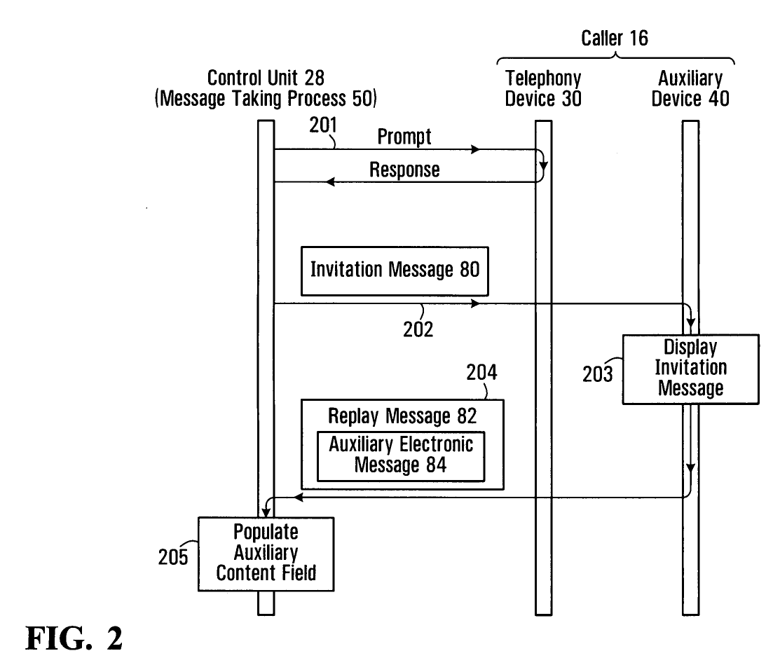

Additionally, and in accordance with embodiments of the present invention, the message taking process 50 interacts with the caller 16 to allow the caller 16 to submit an auxiliary electronic message, which is used to populate the auxiliary content field 24 of the message 22. To this end, and with reference to FIG. 2, the following steps may be performed either before, during or after the caller 16 has recorded a voice segment for the intended recipient 34, thereby allowing the caller 16 to submit an auxiliary electronic message.

It should also be understood that in some cases, the caller 16 may not wish to record a voice segment for the intended recipient 34, and thus the message taking process 50 may proceed directly to the steps described below.

Step 201

This optional step provides for the control unit 28 to send a prompt (such as a voice prompt) to the caller 16, asking the caller 16 whether the caller 16 would like to submit an auxiliary electronic message. The caller 16 may answer by dialing a DTMF tone (e.g., pressing a button on a telephone) or uttering “yes” or providing another possible response. Upon detecting the response (e.g., using tone detection, speech recognition, etc.) and concluding that the caller 16 indeed wishes to submit an auxiliary electronic message, the control unit 28 passes to step 202.

Step 202

If the control unit 28 has learned (or otherwise infers) that the caller 16 wishes to submit an auxiliary electronic message, the control unit 28 provides the caller 16 with an opportunity to submit such auxiliary electronic message. For example, the control unit 28 can initiate an interaction with the caller 16 via the auxiliary device 40 by sending an invitation message 80 to electronically invite the caller 16 to submit an auxiliary electronic message. The control unit 28 can send the invitation message 80 in various ways, such as by way of instant message, email message, real-time text message (including SMS), etc., depending on the nature of the auxiliary device 40 (or the combined device 30, 40, if applicable).

In order to allow the caller 16 to receive the invitation message 80 on the auxiliary device 40 (or the combined device 30, 40, if applicable), the control unit 28 needs to know an address of the caller 16 at which the caller 16 can be reached when using the auxiliary device 40 (or the common device 30, 40, if applicable). This address is hereinafter referred to as an “auxiliary address” of the caller 16. The auxiliary address of the caller 16 can be obtained in various ways, depending on the embodiment, as now described.
FIG. 1A: The control unit 28 consults a database (not shown) in the voice mail system 12 where the auxiliary address of the caller 16 may be associated with a directory number of the telephony device 30 (when the latter is embodied as a telephone). For its part, the directory number of the telephony device 30 can be obtained using technologies such as caller line identification (CLID). Thus, the control unit 28 learns the directory number of the telephony device 30 and maps it to the auxiliary address of the caller 16.
   Since in this case the telephony device 30 is different from the auxiliary device 40 (e.g., a computing apparatus), the association between the directory number of the telephony device 30 and the auxiliary address of the caller 16 may be left to the caller 16 to define. Accordingly, this association may be established by way of a prior registration process. This registration process can be initiated by the caller 16 or by a service provider (e.g., telephony service provider or Internet service provider).
   FIG. 1B: The auxiliary address of the caller 16 can be a MAC address of the common device 30, 40 (e.g., a soft client enabled device). Accordingly, the auxiliary address may be learned from the headers of packets received from the common device 30, 40, which will specify the MAC address of the common device 30, 40.
FIG. 1C: The auxiliary address of the caller 16 can be an electronic serial number of the common device 30, 40 (e.g., a cellular phone or networked PDA). Accordingly, the auxiliary address may be learned from the signals received from the common device 30, 40, which will specify the electronic serial number of the common device 30, 40.
FIG. 1D: The auxiliary address of the caller 16 can be an IP address of the common device 30, 40 (e.g., an IP phone). Accordingly, the auxiliary address may be learned from the headers of packets received from the common device 30, 40, which will specify the IP address of the common device 30, 40.
FIG. 1E: The control unit 28 consults a database (not shown) in the voice mail system 12 where the auxiliary address of the caller 16 may be associated with an IP address of the telephony device 30 (when the latter is embodied as an IP phone). For its part, the IP address of the telephony device 30 can be learned from the headers of packets received from the telephony device 30. Thus, the control unit 28 learns the IP address of the telephony device 30 and maps it to the auxiliary address of the caller 16.
   Since in this case the telephony device 30 is different from the auxiliary device 40 (e.g., a computing apparatus), the association between the IP address of the telephony device 30 and the auxiliary address of the caller 16 may be left to the caller 16 to define. Accordingly, this association may be established by way of a prior registration process. This registration process can be initiated by the caller 16 or by a service provider (e.g., telephony service provider or Internet service provider).

Step 203

The auxiliary device 40 (or the common device 30, 40, if applicable) displays the invitation message 80. In a non-limiting example embodiment, this may be done using a pop-up window, browser window or other GUI.

Step 204

The caller 16 uses the auxiliary device 40 (or the common device 30, 40 if applicable) to respond to the invitation message 80. Specifically, the caller 16 responds by creating an auxiliary electronic message 84, which is then formatted/encapsulated into a reply message 82 and sent to the voice mail system 12.

The auxiliary electronic message 84 may take on a variety of forms, depending on the capabilities of the auxiliary device 40 (or the common device 30, 40, if applicable). In a first suitable non-limiting example, the auxiliary electronic message includes text, which may convey any desired information, such as a context indicator, a URL (uniform resource locator), an alphanumeric code (such as a personal identification number PIN), etc. In a second suitable non-limiting example, the auxiliary electronic message includes a file, which may convey any desired information, such as an electronic business card, an audio segment, a video segment, text, graphics, multimedia, digital signature, etc., or any combination thereof. In a third suitable non-limiting example, the auxiliary electronic message includes a combination of text and a file.

In order to create the auxiliary electronic message 84 and trigger its transmission to the voice mail system 12, the caller 16 may interact with the pop-up window, browser or other GUI that displayed the invitation message at step 203.

Step 205

The control unit 28 receives the reply message 82 containing the auxiliary electronic message 84 and populates the auxiliary content field 24 of the message 22 with the auxiliary electronic message 84.

II-Interaction Between Voice Mail System 12 and Intended Recipient 34

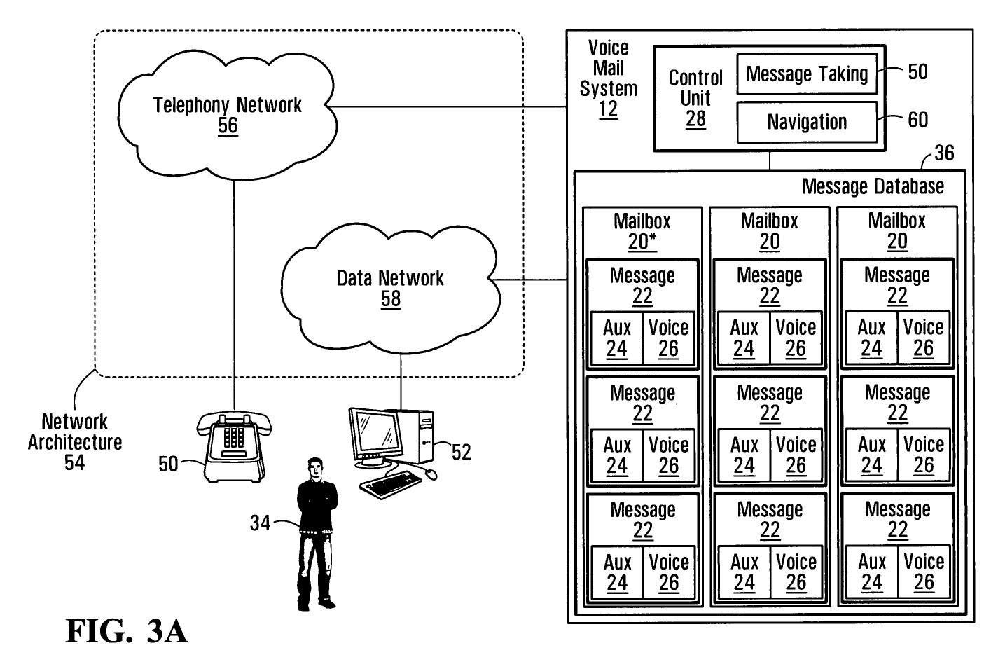

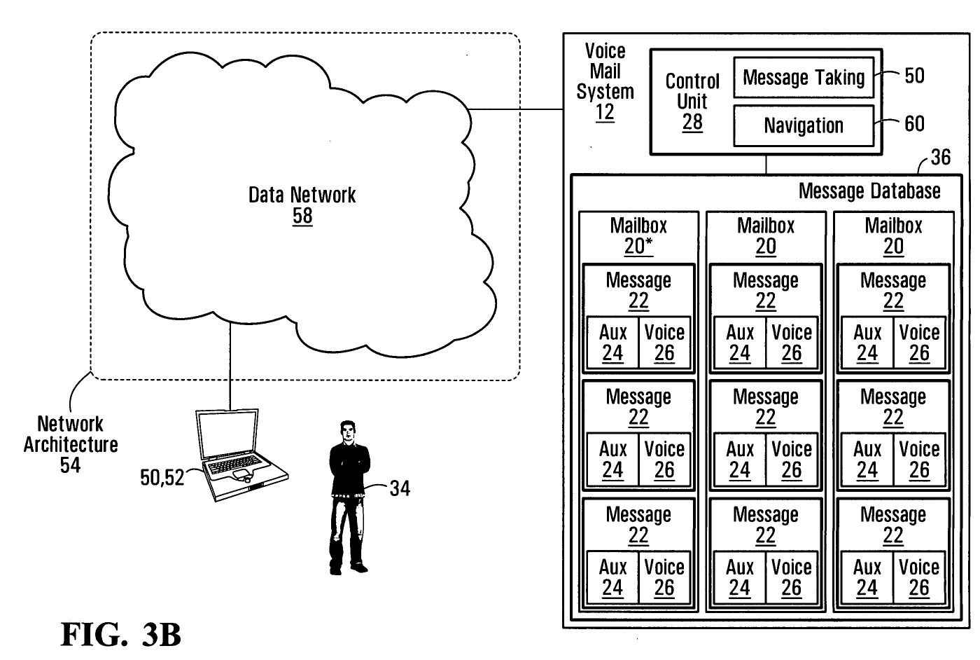

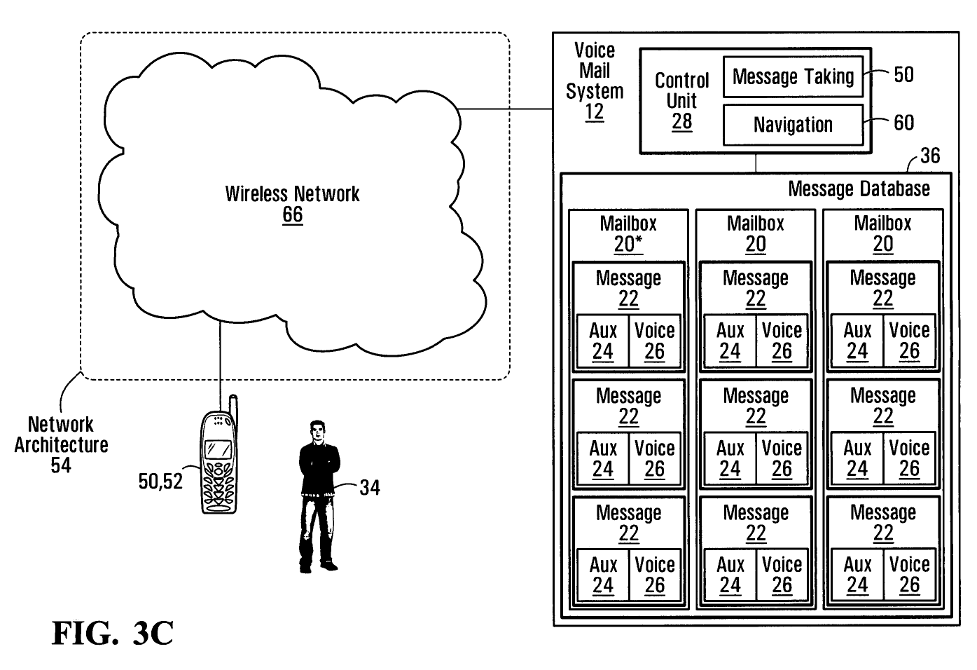

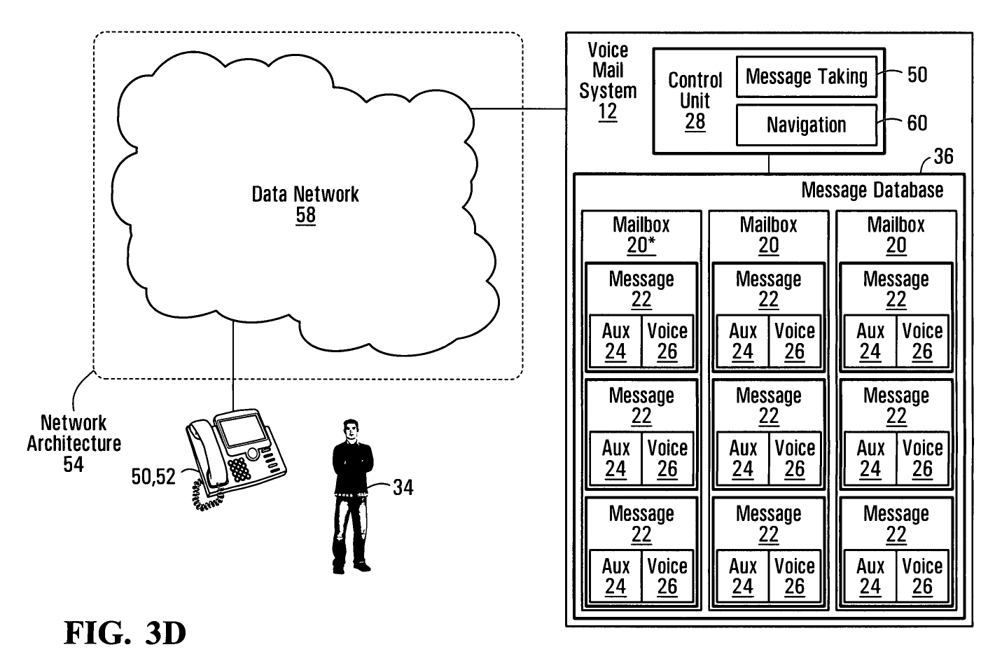

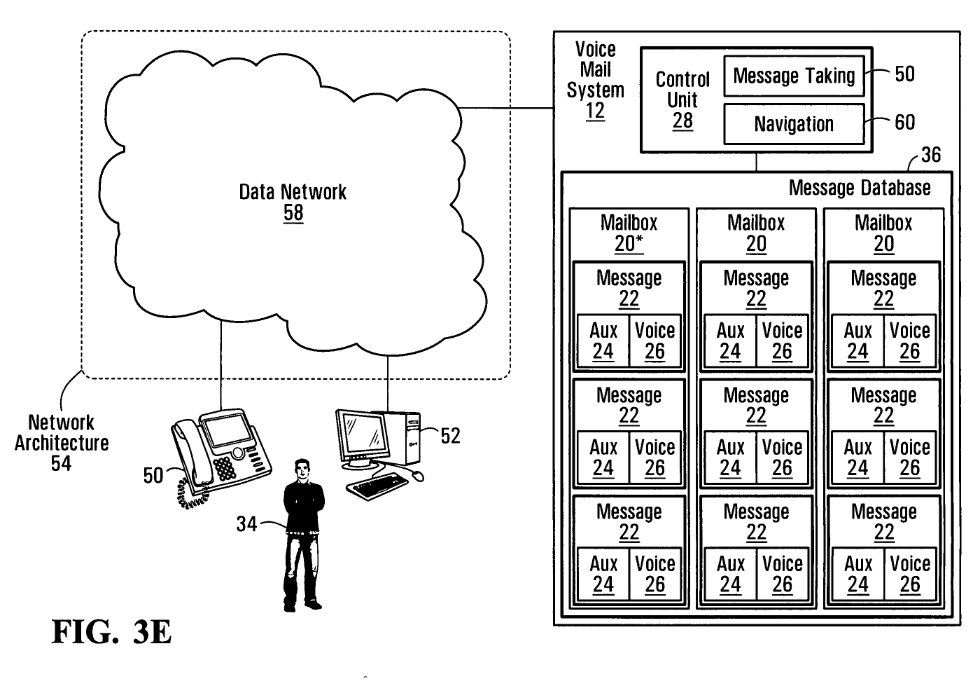

With reference now to FIGS. 3A-3E, there is shown a plurality of scenarios in which the intended recipient 34 retrieves his or her messages 22 from the voice mail system 12. The voice mail system 12 is reachable over a network architecture 54 to which the intended recipient 34 is connected by a telephony device 50 and an auxiliary device 52. Where the voice mail system 12 is associated with a telephone number, the intended recipient 34 can dial the telephone number of the voice mail system 12 using the telephony device 50. If the voice mail system 12 is ultimately reachable at an IP address via a data network, the telephone number may be translated into this IP address at some point in the network architecture 54.

The telephony device 50 may be the same as the auxiliary device 52 or it may be different, as will now become apparent from a discussion of the non-limiting examples in FIGS. 3A through 3E.

In the embodiment of FIG. 3A, the network architecture 54 comprises a telephony network 56 such as the PSTN and a data network 58 such as the Internet. In this embodiment, the telephony device 50 can be a conventional telephone connected to the telephony network 56. The auxiliary device 52 can be a computing apparatus with a connection to the data network 58. In some embodiments, the auxiliary device 52 may connect to the data network 58 via the telephony network 56. The voice mail system 12 is connected to both the telephony network 56 and to the data network 58.

In the embodiment of FIG. 3B, the network architecture 54 comprises a data network 58 such as the Internet. In this embodiment, the telephony device 50 is the same as the auxiliary device 52, and can be referred to as a common device 50, 52. The common device 50, 52 can be a soft client enabled device (e.g., a telephony-enabled desktop, laptop or portable computer) connected to the data network 58. The voice mail system 12 is connected to the data network 58. In some embodiments, the voice mail system 12 may connect to the data network 58 via a telephony network (not shown).

In the embodiment of FIG. 3C, the network architecture 54 comprises a wireless network 66 such as a cellular network. In this embodiment, the telephony device 50 is the same as the auxiliary device 52, and can be referred to as a common device 50, 52. The common device 50, 52 can be a wireless device such as a cellular telephone or a networked personal digital assistant (PDA). The wireless device can have a small screen and a keypad with a plurality of keys. The voice mail system 12 is connected to the wireless network 66. In some embodiments, the voice mail system 12 may connect to the wireless network 66 via a telephony network (not shown).

In the embodiment of FIG. 3D, the network architecture 54 comprises a data network 58 such as the Internet. In this embodiment, the telephony device 50 is the same as the auxiliary device 52, and can be referred to as a common device 50, 52. The common device 50, 52 can be an IP phone. The IP phone can have a screen and a plurality of keys, which have different functions depending on the information displayed on the screen. The IP phone may thus implement “soft key” functionality. The voice mail system 12 is connected to the data network 58. In some embodiments, the voice mail system 12 may connect to the data network 58 via a telephony network (not shown).

In the embodiment of FIG. 3E, the network architecture 54 comprises a data network 58 such as the Internet. In this embodiment, the telephony device 50 can be an IP phone and the auxiliary device 52 can be a computing apparatus. The voice mail system 12 is connected to the data network 58. In some embodiments, the voice mail system 12 may connect to the data network 58 via a telephony network (not shown).

It should be understood that the telephony network 56 may be the same as the telephony network 42, the data network 58 may be the same as the data network 44 and the wireless network 66 may be the same as the wireless network 46.

As can be seen in FIGS. 3A-3E, the control unit 28 in the voice mail system 12 runs a navigation process 60. The navigation process 60 is adapted for interacting with the intended recipient 34 to allow the intended recipient 34 to navigate through his or her messages 22 in mailbox 20*. The navigation process 60, which may be run in hardware, software, control logic or any combination thereof, is now described in greater detail.

Navigation Process 60

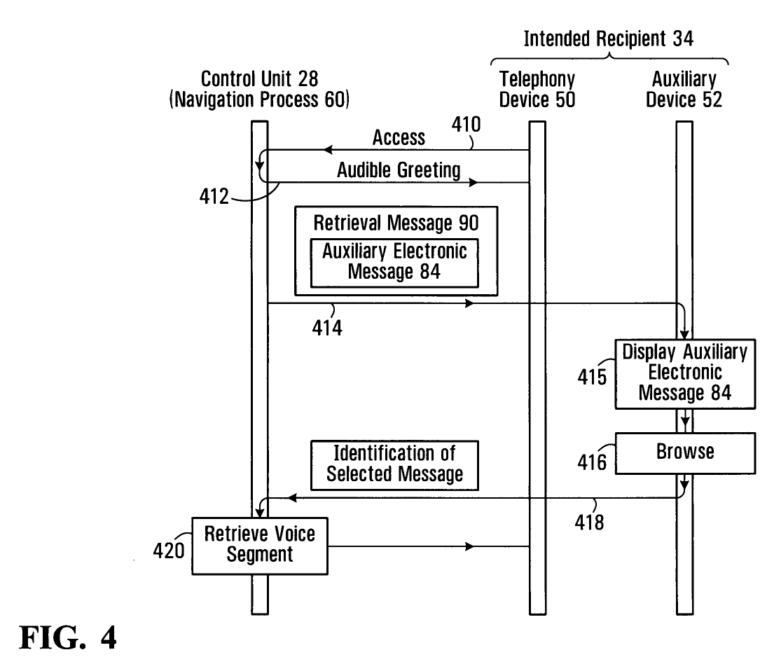

The navigation process 60 interacts with the intended recipient 34 to allow the intended recipient 34 to (a) listen to voice segments stored in the voice content field 26 of the messages 22 in mailbox 20* and (b) access auxiliary electronic messages stored in the auxiliary content field 24 of the messages 22. To this end, the following steps may be performed, with reference to FIG. 4.

Step 410

The intended recipient 34 accesses the voice mail system 12 using the telephony device 50 (or the common device 50, 52, if applicable). Specifically, the intended recipient 34 can authenticate himself/herself in a conventional way and may subsequently access mailbox 20*.

Step 412

In this step, which is optional, the control unit 28 in the voice mail system 12 plays an audible greeting, which is heard by the intended recipient 34 by means of a speaker incorporated into the telephony device 50 (or the common device 50, 52, if applicable).

Step 414

The control unit 28 delivers a retrieval message 90 to the auxiliary device 52 (or the common device 50, 52, if applicable). The retrieval message 90 includes the auxiliary electronic messages in the auxiliary content field 24 of the messages 22 in mailbox 20*. In the present example, this also includes the auxiliary electronic message 84 that was submitted by the caller 16 as described earlier.

Step 415

The auxiliary device 52 (or the common device 50, 52, if applicable) extracts the auxiliary electronic messages from the retrieval message 90 and displays the auxiliary electronic messages for perusal by the intended recipient 34. Display of the auxiliary messages may take on various forms, depending on the embodiment. For example, display of the auxiliary electronic messages may take the form of a graphical user interface (GUI), such as an interactive window.

In the specific case where a particular auxiliary electronic message comprises text that conveys a URL, the auxiliary device 52 (or the common device 50, 52, if applicable) can be adapted for recognizing the URL and providing, in the GUI, an actionable link to the associated address on the Internet, as is done in various currently available software products such as Microsoft Word™. Non-limiting ways of actioning the link include clicking with the aid of a mouse, pressing a sequence of keys or buttons, touching a screen with a finger, using a stylus, etc.

Step 416

The intended recipient 34 browses the GUI using the auxiliary device 52 (or the common device 50, 52, if applicable). Depending on the nature of the auxiliary device 52 (of the common device 50, 52, if applicable), browsing may be achieved by using any one or more of a mouse, a button, a soft key, a stylus, etc. Browsing may also involve ultimately “opening” a file.

Step 418

As a result of browsing the GUI, the intended recipient 34 can identify a particular auxiliary electronic message whose corresponding voice segment is of potential interest to the intended recipient 34. The message that includes the particular auxiliary electronic message and the corresponding voice segment may be referred to as a “selected message”.

The intended recipient identifies the selected message to the control unit 28. This may be done either using the telephony device 50, or using the auxiliary device 52 or using the common device 50, 52 (if applicable).

Step 420

The control unit 28 plays back the voice segment in the voice content field 26 of the selected message. Playback is heard by the intended recipient 34 by means of a speaker incorporated into the telephony device 50 (or the common device 50, 52, if applicable).

At this point, the intended recipient 34 may continue browsing among the auxiliary electronic messages in the GUI and, as such, the navigation process 60 may return to step 416, which may result in selection of another message and playback of the corresponding voice segment, and so on.

In the above embodiment, it is noted that the intended recipient 34 need not listen to any particular voice segment before navigating among the auxiliary electronic messages in the GUI. This may save bandwidth because unnecessary playback of voice segments is avoided.

It will thus be appreciated that the ability of a caller 16 to submit text and/or files increases the accuracy and flexibility with which certain types of information (e.g., contact information, images, URLs, etc.) can be conveyed to the intended recipient 34. At the same time, the ability of the intended recipient 34 to access text and/or files associated with individual messages allows the intended recipient 34 to better manage missed calls when eventually accessing his or her mailbox 20*.

In a variant of the embodiment of FIG. 4, the retrieval message 90 delivered at step 414 may include, in addition to the auxiliary messages in the auxiliary content field 24 of the messages 22 in mailbox 20*, also the voice segments in the voice content field 26 of the messages 22 in mailbox 20*. This will allow the messages 22 to be organized using a message management interface (e.g., similar to Microsoft Outlook™), with voice segments and auxiliary messages being accessible entirely through the auxiliary device 52 (or the common device 50, 52, if applicable). For example, an individual message may be represented in the message management interface by a display icon which, when clicked, causes playback of the associated voice segment. Also, an individual message that has an associated auxiliary electronic message may be represented in the message management interface by a further icon which, when clicked, causes the associated auxiliary electronic message to be displayed or opened.

In another variant of the embodiment of FIG. 4, particularly applicable when the auxiliary electronic messages are large in size, the retrieval message 90 can be formulated to include a redacted version of one or more of these “large” auxiliary electronic messages. For example, in the case of an auxiliary electronic message containing an image or video segment, the retrieval message 90 may include a thumbnail of that image or video segment for display by the auxiliary device 52 (or the common device 50, 52, if applicable) using the GUI. This has the effect of increasing the usability of the information being presented to the intended recipient 34 when conducting step 416. In order to access the entire image or video segment, the intended recipient 34 may be permitted to click on or otherwise select the thumbnail. The selection can be transmitted back to the voice mail system 12 by way of a message that identifies the selected thumbnail.

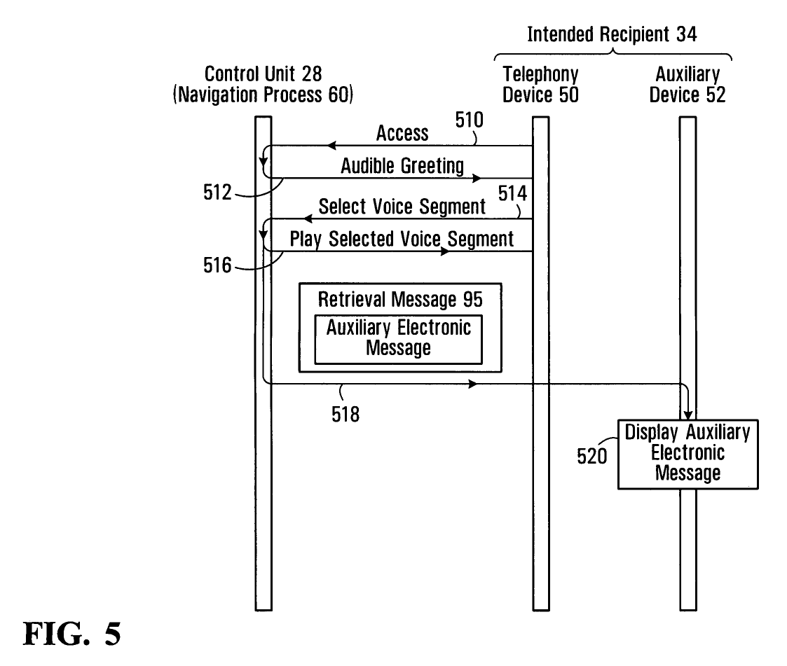

In another variant, the intended recipient 34 selects a message on the basis of its voice segment rather than on the basis of its auxiliary electronic message. This variant is now described in greater detail with reference to FIG. 5.

Step 510

The intended recipient 34 accesses the voice mail system 12 using the telephony device 50 (or the common device 50, 52, if applicable). Specifically, the intended recipient 34 can authenticate himself/herself in a conventional way and may subsequently access mailbox 20*.

Step 512

In this step, which is optional, the control unit 28 in the voice mail system 12 plays an audible greeting, which is heard by the intended recipient 34 by means of a speaker incorporated into the telephony device 50 (or the common device 50, 52, if applicable).

Step 514

The intended recipient 34 selects a voice segment (e.g., the first voice segment) for playback. The selection may be effected in a conventional way using the telephony device 50 (or the common device 50, 52, if applicable).

Step 516

The control unit 28 plays back the selected voice segment. Playback of the selected voice segment is heard by the intended recipient 34 by means of a speaker incorporated into the telephony device 50 (or the common device 50, 52, if applicable).

Step 518

At this step, which is responsive to step 514 but may be performed before, during or after step 516, the control unit 28 delivers a retrieval message 95 to the auxiliary device 52 (or the common device 50, 52, if applicable). The retrieval message 95 includes the auxiliary electronic message found in the auxiliary content field 24 of the message 22 that contained, in its voice content field 26, the selected voice segment.

If the auxiliary electronic message is large in size, the retrieval message 95 can be formulated to include a redacted version of the auxiliary electronic message. For example, in the case of an auxiliary electronic message containing an image or video segment, the retrieval message 95 may include a thumbnail of that image or video segment.

Step 520

The auxiliary device 52 (or the common device 50, 52, if applicable) extracts the auxiliary electronic message (or redacted version thereof) from the retrieval message 95 and displays the auxiliary electronic message for the intended recipient 34. Display of the auxiliary message may take on various forms, depending on the embodiment. For example, display of the auxiliary electronic message may take the form of a graphical user interface (GUI), such as an interactive window.

In the specific case where a particular auxiliary electronic message comprises text that conveys a URL, the auxiliary device 52 (or the common device 50, 52, if applicable) can be adapted for recognizing the URL and providing, in the GUI, a clickable hyperlink to the associated address on the Internet, as is done in various currently available software packages such as Microsoft Word™.

In other cases, e.g., where a particular auxiliary electronic message comprises a file, the auxiliary device 52 (or the common device 50, 52, if applicable) can be adapted for allowing the file to be opened immediately or represented by a clickable icon in the GUI.

In the specific case where the retrieval message 95 comprises a thumbnail of a particular image or video segment, the auxiliary device 52 (or the common device 50, 52, if applicable) can be adapted for displaying the thumbnail in the GUI. In order to access the entire image or video segment, the intended recipient 34 may be permitted to click on or otherwise identify the thumbnail via the GUI.

At this point, the navigation process 60 may return to step 514, where the intended recipient 34 selects another voice segment for playback, which results in delivery of the associated auxiliary electronic message, and so on.

It will thus be appreciated that the ability of a caller 16 to submit text and/or files increases the accuracy and flexibility with which certain types of information (e.g., contact information, images, URLs, etc.) can be conveyed to the intended recipient 34. At the same time, the ability of the intended recipient 34 to access text and/or files associated with individual messages allows the intended recipient 34 to better manage missed calls when eventually accessing his or her mailbox 20*.

Those skilled in the art will appreciate that in the above embodiments, in order to know where to send the retrieval message (90 or 95), the control unit 28 needs to know an auxiliary address of the intended recipient 34, i.e., the address at which the intended recipient 34 can be reached when using the auxiliary device 52 (or the common device 50, 52, if applicable). Various ways of obtaining an auxiliary address have been described earlier on with reference to the various scenarios in FIGS. 1A-1E in the case of the caller 16. As such, and recognizing the architectural similarities between the examples of FIGS. 1A-1E and the examples of FIGS. 3A-3E, one skilled in the art should be capable of obtaining the auxiliary address of the intended recipient 34 by applying similar techniques as were used in FIGS. 1A-1E for the purposes of obtaining the auxiliary address of the caller 16. One additional non-limiting way of obtaining the auxiliary address of the intended recipient 34 is by consulting a database that associates each mailbox 20 (including mailbox 20*) with an associated intended recipient (including the intended recipient 34).

Those skilled in the art will appreciate that in some embodiments, the functionality of the control unit 28 (including the message taking process 50 and the navigation process 60) may be implemented as pre-programmed hardware or firmware elements (e.g., application specific integrated circuits (ASICs), electrically erasable programmable read-only memories (EEPROMs), etc.), or other related components. In other embodiments, the control unit 28 may be implemented as an arithmetic and logic unit (ALU) having access to a code memory (not shown) which stores program instructions for the operation of the ALU. The program instructions could be stored on a medium which is fixed, tangible and readable directly by the control unit 28, (e.g., removable diskette, CD-ROM, ROM, fixed disk, USB drive, etc.), or the program instructions could be stored remotely but transmittable to the control unit 28 via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

While specific embodiments of the present invention have been described and illustrated, it will be apparent to those skilled in the art that numerous modifications and variations can be made without departing from the scope of the invention as defined in the appended claims.

What is claimed is:

1. A method suitable for execution by a voice mail system for handling a call placed by a caller, comprising:
providing the caller with an opportunity to submit a voice segment destined for an intended recipient;
providing the caller with an opportunity to submit an auxiliary electronic message destined for the intended recipient;
storing in a mailbox associated with the intended recipient a composite message comprising the voice segment and the auxiliary electronic message;
releasing the auxiliary electronic message to the intended recipient upon interaction with the intended recipient.

2. The method defined in claim 1, wherein said providing the caller with an opportunity to submit a voice segment destined for an intended recipient is executed before said providing the caller with an opportunity to submit an auxiliary electronic message destined for the intended recipient.

3. The method defined in claim 1, wherein said providing the caller with an opportunity to submit a voice segment destined for an intended recipient is executed after said providing the caller with an opportunity to submit an auxiliary electronic message destined for the intended recipient.

4. The method defined in claim 1, further comprising determining a positive intention of the caller to submit the auxiliary electronic message.

5. The method defined in claim 1, further comprising sending an invitation message to an auxiliary address associated with the caller.

6. The method defined in claim 5, wherein the invitation message is an instant message.

7. The method defined in claim 5, wherein the invitation message is an email message.

8. The method defined in claim 5, wherein the invitation message is a real-time text message.

9. The method defined in claim 5, further comprising obtaining knowledge of the auxiliary address associated with the caller.

10. The method defined in claim 9, wherein said obtaining knowledge of the auxiliary address associated with the caller comprises consulting a database that associates the auxiliary address of the caller with a directory number of a device used by the caller to place the call.

11. The method defined in claim 10, wherein said obtaining knowledge of the auxiliary address associated with the caller further comprises obtaining the directory number of the device used by the caller to place the call.

12. The method defined in claim 11, wherein the directory number of the device used by the caller to place the call is obtained from calling line identification (CLID) information associated with the call.

13. The method defined in claim 12, wherein the auxiliary address associated with the caller comprises an IP address of a networked computing apparatus.

14. The method defined in claim 9, wherein the auxiliary address associated with the caller comprises an address of a device used by the caller to place the call.

15. The method defined in claim 14, wherein said obtaining knowledge of the auxiliary address associated with the caller comprises observing packets sent by the device used by the caller to place the call, thereby to learn the address of the device used by the caller to place the call.

16. The method defined in claim 15, wherein said address is a MAC address of a computing apparatus implementing a soft client.

17. The method defined in claim 15, wherein said address is an IP address of an IP phone.

18. The method defined in claim 15, wherein said address is a electronic serial number of a wireless device.

19. The method defined in claim 18, wherein said wireless device is at least one of a cellular phone and a networked personal digital assistant.

20. The method defined in claim 9, wherein said obtaining knowledge of the auxiliary address associated with the caller comprises consulting a database that associates the auxiliary address of the caller with an address of an IP phone used by the caller to place the call.

21. The method defined in claim 20, wherein said obtaining knowledge of the auxiliary address associated with the caller further comprises observing packets sent by the IP phone used by the caller to place the call, thereby to learn the address of the IP phone used by the caller to place the call.

22. The method defined in claim 21, wherein the auxiliary address associated with the caller comprises an IP address of a networked computing apparatus.

23. The method defined in claim 5, wherein the invitation message is instrumental in causing a device used by the caller to display a pop-up window inside which the caller is allowed to submit the auxiliary electronic message.

24. The method defined in claim 5, wherein the invitation message is instrumental in causing a device used by the caller to display a browser window via which the caller is capable of submitting the auxiliary electronic message.

25. The method defined in claim 5, wherein the invitation message is instrumental in causing a device used by the caller to place the call to implement a graphical user interface allowing the caller to submit the auxiliary electronic message.

26. The method defined in claim 5, further comprising receiving a reply message responsive to the invitation message, the reply message containing the auxiliary electronic message.

27. The method defined in claim 26, wherein the auxiliary electronic message comprises text.

28. The method defined in claim 27, wherein said text conveys at least one of a context indicator, a uniform resource locator, and an alphanumeric code.

29. The method defined in claim 26, wherein the auxiliary electronic message comprises a file.

30. The method defined in claim 27, wherein the auxiliary electronic message comprises a file.

31. The method defined in claim 29, wherein said file conveys at least one of an electronic business card, an audio segment, a video segment, text, graphics, multimedia, and digital signature.

32. The method defined in claim 1, wherein the composite message comprises a first field containing the voice segment and a second field containing the auxiliary electronic message.

33. The method defined in claim 1, wherein said releasing the auxiliary electronic message to the intended recipient is executed in response to successful authentication of the intended recipient.

34. The method defined in claim 1, wherein said releasing the auxiliary electronic message to the intended recipient comprises sending a retrieval message to an auxiliary address associated with the intended recipient, the retrieval message comprising at least the auxiliary electronic message.

35. The method defined in claim 34, wherein the retrieval message is an instant message.

36. The method defined in claim 34, wherein the retrieval message is an email message.

37. The method defined in claim 34, wherein the retrieval message is a real-time text message.

38. The method defined in claim 34, further comprising obtaining knowledge of the auxiliary address associated with the intended recipient.

39. The method defined in claim 38, wherein said obtaining knowledge of the auxiliary address associated with the intended recipient comprises consulting a database that associates the auxiliary address of the intended recipient with a directory number of a device used by the intended recipient to interact with the voice mail system.

40. The method defined in claim 39, wherein said obtaining knowledge of the auxiliary address associated with the intended recipient further comprises obtaining the directory number of the device used by the intended recipient to interact with the voice mail system.

41. The method defined in claim 40, wherein the directory number of the device used by the intended recipient to interact with the voice mail system is obtained from calling line identification (CLID) information generated as a result of interaction of the intended recipient with the voice mail system.

42. The method defined in claim 41, wherein the auxiliary address associated with the intended recipient comprises an IP address of a networked computing apparatus.

43. The method defined in claim 38, wherein the auxiliary address associated with the intended recipient comprises an address of a device used by the intended recipient to interact with the voice mail system.

44. The method defined in claim 43, wherein said obtaining knowledge of the auxiliary address associated with the intended recipient comprises observing packets sent by the device used by the intended recipient to interact with the voice mail system, thereby to learn the address of the device used by the intended recipient to interact with the voice mail system.

45. The method defined in claim 44, wherein said address is a MAC address of a computing apparatus implementing a soft client.

46. The method defined in claim 44, wherein said address is an IP address of an IP phone.

47. The method defined in claim 44, wherein said address is a electronic serial number of a wireless device.

48. The method defined in claim 47, wherein said wireless device is at least one of a cellular phone and a networked personal digital assistant.

49. The method defined in claim 38, wherein said obtaining knowledge of the auxiliary address associated with the intended recipient comprises consulting a database that associates the auxiliary address associated with the intended recipient with an address of an IP phone used by the intended recipient to interact with the voice mail system.

50. The method defined in claim 49, wherein said obtaining knowledge of the auxiliary address associated with the intended recipient further comprises observing packets sent by the IP phone used by the intended recipient to interact with the voice mail system, thereby to learn the address of the IP phone used by the intended recipient to interact with the voice mail system.

51. The method defined in claim 50, wherein the auxiliary address associated with the intended recipient comprises an IP address of a networked computing apparatus.

52. The method defined in claim 38, wherein said obtaining knowledge of the auxiliary address associated with the intended recipient comprises consulting a database that associates the mailbox associated with the intended recipient with the auxiliary address of the intended recipient.

53. The method defined in claim 34, wherein processing of the retrieval message at a device used by the intended recipient to interact with the voice mail system is instrumental in causing the auxiliary electronic message to be extracted by said device.

54. The method defined in claim 53, wherein when the auxiliary electronic message comprises text, extraction of the auxiliary electronic message causes display of said text on said device.

55. The method defined in claim 34, wherein the retrieval message comprises a plurality of messages including the auxiliary electronic message, wherein processing of the retrieval message at a device used by the intended recipient to interact with the voice mail system is instrumental in causing the plurality of messages to be extracted by said device and conveyed to the intended recipient via a graphical user interface.

56. The method defined in claim 55, further comprising receiving from the intended recipient a selection of a particular one of the plurality of messages and sending to the intended recipient a voice segment associated with the selected message.

57. The method defined in claim 34, wherein said releasing the auxiliary electronic message is executed in response to receipt of a selection from the intended recipient identifying the composite message.

58. The method defined in claim 57, wherein the selection is received from a telephony device associated with the intended recipient.

59. The method defined in claim 57, wherein the selection is received from an auxiliary device associated with the intended recipient.

60. The method defined in claim 1, wherein said releasing the auxiliary electronic message to the intended recipient comprises:
sending to an auxiliary address associated with the intended recipient a redacted version of the auxiliary electronic message;
responsive to a message indicative of a selection of the redacted version of the auxiliary electronic message, sending the auxiliary electronic message to the auxiliary address associated with the intended recipient.

61. The method defined in claim 60, wherein the auxiliary electronic message comprises a file conveying an image segment and wherein the redacted version of the auxiliary electronic message comprises a file conveying a thumbnail of the image segment.

62. The method defined in claim 60, wherein the auxiliary electronic message comprises a file conveying a video segment and wherein the redacted version of the auxiliary electronic message comprises a file conveying a thumbnail of the video segment.

63. The method defined in claim 1, the auxiliary electronic message being a particular auxiliary electronic message, wherein said releasing the auxiliary electronic message to the intended recipient comprises sending a retrieval message to an auxiliary address associated with the intended recipient, the retrieval message comprising a plurality of auxiliary electronic messages including the particular auxiliary electronic message.

64. The method defined in claim 63, wherein the retrieval message is instrumental in causing a device used by the intended recipient to interact with the voice mail system to implement a message management interface to visually organize the plurality of auxiliary electronic messages.

65. The method defined in claim 1, the auxiliary electronic message being a particular auxiliary electronic message, the voice segment being a particular voice segment, wherein said releasing the auxiliary electronic message to the intended recipient comprises sending a retrieval message to an auxiliary address associated with the intended recipient, the retrieval message comprising a plurality of auxiliary electronic messages including the particular auxiliary electronic message and a plurality of voice segments including the particular voice segment.

66. The method defined in claim 65, wherein the retrieval message is instrumental in causing a device used by the intended recipient to interact with the voice mail system to implement a message management interface to visually organize the plurality of auxiliary electronic messages and the plurality of voice segments.

67. The method defined in claim 34, wherein the auxiliary electronic message conveys a uniform resource locator, wherein the retrieval message is instrumental in causing a device used by the intended recipient to interact with the voice mail system to implement a message management interface to allow the uniform resource locator to be actionable by the intended recipient.

68. Computer-readable media tangibly embodying a program of instructions executable by a computing device to perform a method of handling a call placed by a caller, the method comprising:
providing the caller with an opportunity to submit a voice segment destined for an intended recipient;
providing the caller with an opportunity to submit an auxiliary electronic message destined for the intended recipient;
storing in a mailbox associated with the intended recipient a composite message comprising the voice segment and the auxiliary electronic message;
releasing the auxiliary electronic message to the intended recipient upon interaction with the intended recipient.

69. A voice mail system, comprising:
a plurality of mailboxes associated with respective users of the voice mail system, each of said mailboxes comprising a respective set of at least one message, at least one particular message in the mailbox associated with a particular user comprising a respective voice content field and a respective auxiliary content field, the voice content field of the particular message comprising a voice segment submitted by a caller during prior interaction with the voice mail system, the auxiliary content field of the particular message comprising an auxiliary electronic message information submitted by the caller during said prior interaction with the voice mail system; and
a control unit operative for interacting with the particular user to allow the particular user to retrieve the voice segment in the voice content field of the particular message and the auxiliary electronic message in the auxiliary content field of the particular message.
